(19) United States
(12) Patent Application Publication
(10) Pub. No.: US 2014/0060974 A1
(43) Pub. Date: Mar. 6, 2014

(54) Idle Gear Remote Grease Line

(71) Applicant: Sean Gagan, Bloomingburg, NY (US)

(72) Inventor: Sean Gagan, Bloomingburg, NY (US)

(21) Appl. No.: 14/014,474

(22) Filed: Aug. 30, 2013

Related U.S. Application Data
(60) Provisional application No. 61/697,349, filed on Sep. 6, 2012.

(51) Int. Cl. F16N 21/02

(52) U.S. Cl. CPC F16N 21/02
USPC 184/105.3

(57) ABSTRACT

A remote grease line device is disclosed that provides users with an efficient device for greasing a grease fitting. The remote grease line device comprises a hose, a nipple fitting secured to an end of the hose, and a bulkhead fitting secured to the opposite end of the hose. Once the nipple fitting and the hose are secured together, the nipple fitting is attached to the device with the grease fitting, then the device is positioned in an easily accessible position in the vehicle to allow for greasing of the device with the grease fitting. A user then secures a grease delivery device (i.e., a grease gun) to the bulkhead fitting for dispensing grease or other fluids into the bulkhead fitting and through the hose to the device with the grease fitting. The device with the grease fitting is typically an idle gear shaft for a racing vehicle.

### CROSS-REFERENCE

This application claims priority from Provisional Patent Application Ser. No. 61/697,349 filed Sep. 6, 2012.

### BACKGROUND

Typically, the idle gear shaft on racing vehicles must be greased lightly each week to prevent misalignment and starter malfunctions. However, once the racing vehicle is assembled it is very difficult to access the grease fitting from inside the racing vehicle. Thus, the current setup requires a user to get into the racing vehicle in order to perform the greasing task. An easier solution is needed.

The present invention is designed to successfully grease an inaccessible grease fitting for an inboard starter idler gear shaft application in auto racing vehicles and other components. The remote grease line device transfers the grease fitting from inside the vehicle to an accessible location outside the vehicle, where it can be easily greased. This device is ideal for use in racing applications, but can be adapted for other vehicle applications as well.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a remote grease line device that provides users with an efficient device for supplying grease to a grease fitting. The remote grease line device comprises a hose and a nipple fitting removably secured to an end of the hose, wherein the nipple fitting and the hose are then positioned in an easily accessible position in a vehicle to allow for greasing of a device with a grease fitting. The nipple fitting can be removably secured to one end of the hose via any suitable securing means known in the art, such as threading. The end of the hose that is opposite of the nipple fitting is then secured to a bulkhead fitting. The bulkhead fitting is then secured to a grease delivery device. Once the nipple fitting and the hose are removably secured together, the nipple fitting is then attached to the device with the grease fitting, then the device is positioned in an easily accessible position in the vehicle to allow for greasing of the device with the grease fitting. A user then secures a grease delivery device (e.g., a prior art grease gun) to the bulk head for dispensing grease or other fluids into the bulk head end and through the hose to the grease fitting on the device to be greased.

In a preferred embodiment, the device with a grease fitting is typically an idle gear shaft for a racing vehicle. However, the device with a grease fitting can be any suitable device in a racing vehicle or other similar vehicle that needs to be periodically greased and is positioned at an inaccessible position on the vehicle for the user. Further, the grease delivery device is typically a grease gun, and a grease line (from the grease gun) is secured to the bulk head for dispensing grease into the hose and through the nipple fitting to the idle gear shaft.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of an inaccessible gear and shaft in accordance with the disclosed architecture.

FIG. 2 illustrates a perspective view of the remote grease line device in accordance with the disclosed architecture.

FIG. 3 illustrates a perspective view of the remote grease line device in use on a racing vehicle in accordance with the disclosed architecture.

FIG. 4 illustrates a perspective view of the remote grease line device in use with a bulkhead fitting in accordance with the disclosed architecture.

FIG. 5 illustrates a perspective view of the remote grease line device in use in accordance with the disclosed architecture.

### DESCRIPTION OF PREFERRED EMBODIMENTS

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The present invention is designed to successfully grease an inaccessible grease fitting for an inboard starter idler gear shaft in auto racing vehicles, other vehicles, equipment and machines with difficult to access grease fittings. The remote grease line device transfers the grease fitting from inside the vehicle to an accessible location outside the vehicle, where it can be easily accessed. This device is ideal for use in racing applications, but can be adapted for other vehicles, equipment, machines, etc. as well.

The disclosed remote grease line device comprises a hose and a nipple fitting removably secured to an end of the hose, wherein the nipple fitting and the hose are then positioned in an easily accessible position in a vehicle to allow for greasing of a device with a grease fitting. Once the nipple fitting and the hose are removably secured together, then the end of the hose that is opposite of the nipple fitting is secured to a bulkhead fitting. The bulkhead fitting is then secured to a grease delivery device. Once the nipple fitting and the hose are removably secured together, the nipple fitting is then attached to the device with the grease fitting, then the device is positioned in an easily accessible position in the vehicle to allow for greasing of the device with the grease fitting. A user then secures a grease delivery device (e.g., a prior art grease gun) to the bulk head for dispensing grease or other fluids into the bulk head end and through the hose to the grease fitting on the device to be greased. The device to be greased is typically an idle gear shaft for a racing vehicle, but could be any device with a grease fitting, or a spare tire carrier, farm equipment, etc.

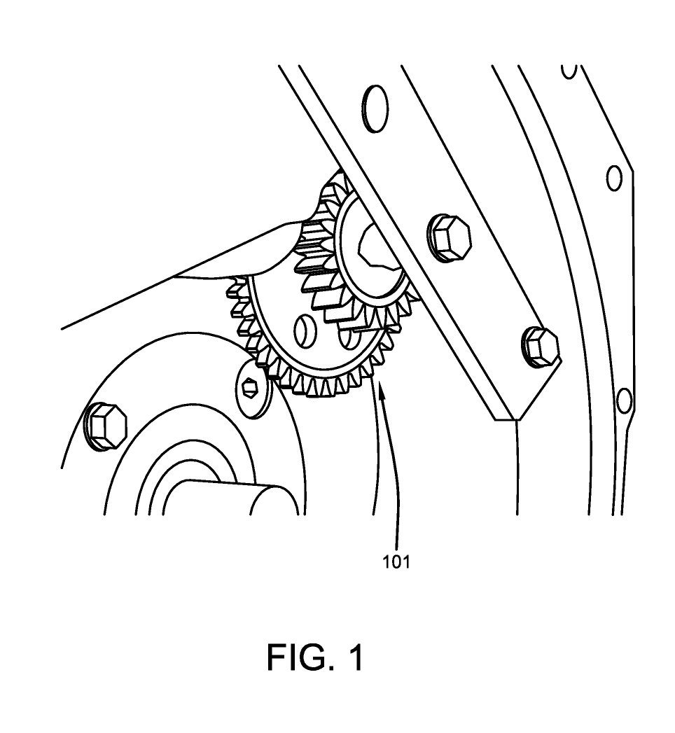

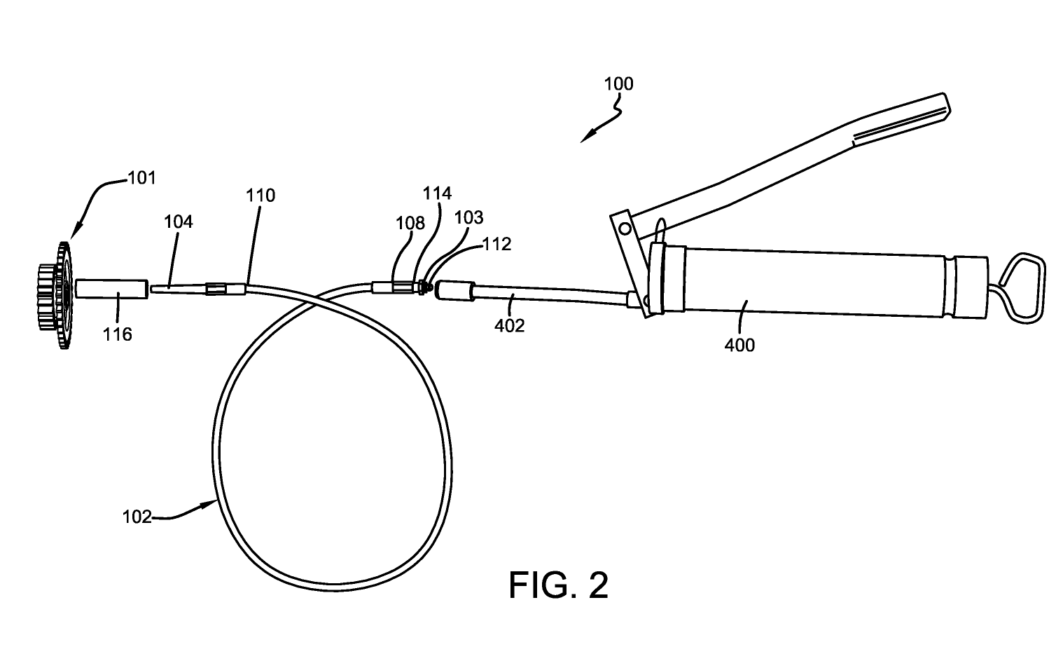

Referring initially to the drawings, FIG. 1 illustrates an inaccessible gear and shaft (i.e., idle gear bushing 101) behind an engine and in front of a transmission, and FIGS. 2-4 illustrate the remote grease line device 100 that provides users with an efficient device for greasing the idle gear shaft 116 to maintain the idle gear bushing 101. The remote grease line device 100 comprises a hose 102 and a nipple fitting 104 removably secured to an end of the hose 102, wherein the nipple fitting 104 and the hose 102 are then positioned in an easily accessible position in a vehicle 106 to allow for greasing of the device with the grease fitting (as shown in FIG. 2).

The hose 102 is preferably flexible and comprises a first end 108, a second end 110, and a continuous opening therein extending between said first end 108 and said second end 110. Typically, the hose 102 is cylindrical in shape, however any other suitable shape can be used as is known in the art without affecting the overall concept of the invention, as long as a substance such as grease can pass through the continuous opening. The hose 102 would generally be constructed of plastic, Kevlar®, or metal, such as steel, iron, stainless steel braid, etc., though any other suitable material may be used to manufacture the hose 102 as is known in the art without affecting the overall concept of the invention.

The hose 102 can also comprise a variety of colors and designs to suit user and manufacturing preference, and can be manufactured in a variety of sizes depending on the wants and needs of a user. The hose 102 can be approximately between 6 and 30 inches long as measured from a first end 108 to a second end 110, and approximately between ¼ and ⅜ inches in diameter.

The remote grease line device 100 further comprises a nipple fitting 104 removably secured to an end of the hose 102. The nipple fitting 104 can be removably secured to either the first end 108 or the second end 110 of the hose 102 via any suitable securing means such as threading, gluing, etc. The nipple fitting 104 would generally be constructed of plastic, or metal, such as steel, iron, etc., though any other suitable material may be used to manufacture the nipple fitting 104 as is known in the art without affecting the overall concept of the invention. The nipple fitting 104 can also comprise a variety of colors and designs to suit user and manufacturing preference, and can be manufactured in a variety of sizes depending on the wants and needs of a user.

Typically, the end of the hose 102 that is opposite of the nipple fitting 104 is then secured to a bulkhead fitting 103. The bulkhead fitting 103 can be removably secured to the hose 102 via any suitable securing means such as threading, gluing, etc. The bulkhead fitting 103 would generally be constructed of plastic, or metal, such as steel, iron, etc., though any other suitable material may be used to manufacture the bulkhead fitting 103 as is known in the art without affecting the overall concept of the invention. The bulkhead fitting 103 can also comprise a variety of colors and designs to suit user and manufacturing preference, and can be manufactured in a variety of sizes depending on the wants and needs of a user.

Typically, the end of the hose 102 that is opposite of the bulkhead fitting 103 is then secured to the device or the existing grease fitting on the device. For example, the device with the grease fitting is typically an idle gear shaft 116 for a racing vehicle 106 (as shown in FIG. 1). However, the device with the grease fitting can be any suitable device in a racing vehicle 106 or other similar vehicle that needs to be periodically greased and is positioned at an inaccessible position on the vehicle 106 for the user.

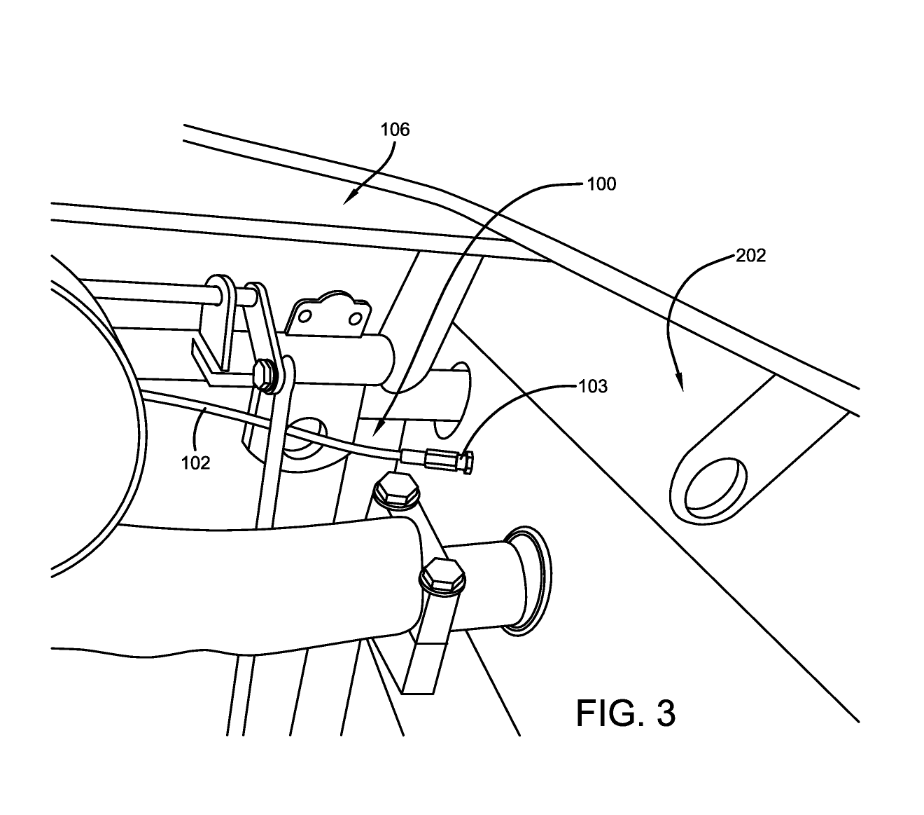

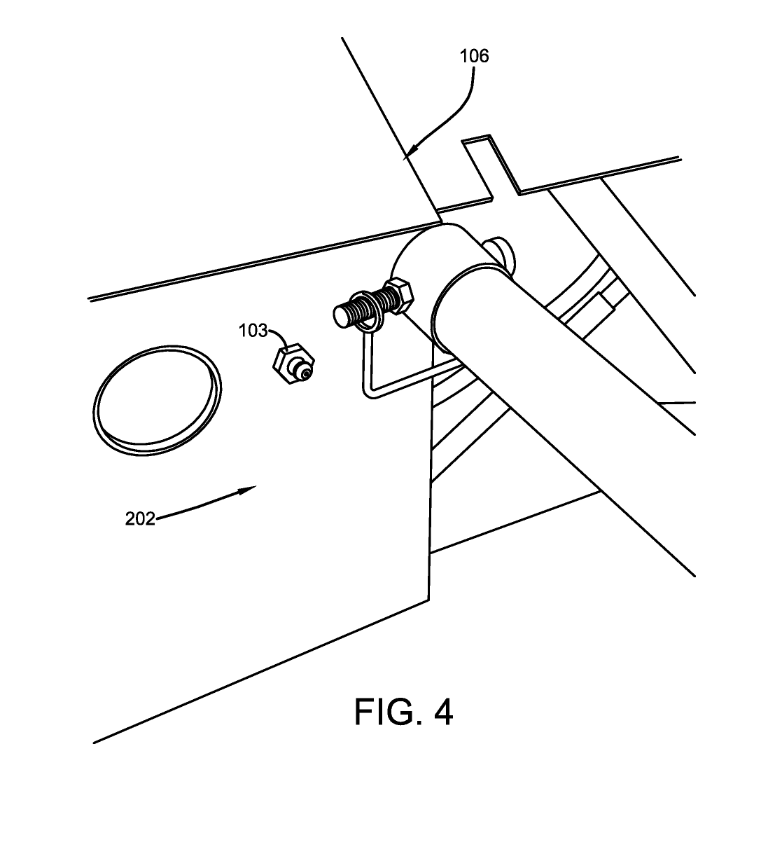

Once the nipple fitting 104 and the hose 102 are removably secured together and then attached to the idle gear shaft 116, the device 100 is then positioned in an easily accessible position in the vehicle 106 to allow for greasing of the device with the grease fitting (i.e., the idle gear shaft 116). Further, the end of the hose 108 with the bulkhead fitting 103 allows the device to be secured through a wall 202 of the vehicle 106 for easy access by a user (as shown in FIGS. 3-4).

A user then can secure a grease delivery device 400 to the bulkhead fitting 103 for dispensing grease or other fluids through the hose 102 to the device with the grease fitting. Typically, the grease delivery device 400 is a grease gun, but can be any suitable grease delivery device 400 as is known in the art. Additionally, a grease line 402 (from the grease gun) is secured to the bulkhead fitting 103 for dispensing grease through the hose 102 to the device with the grease fitting (i.e., the idle gear shaft 116).

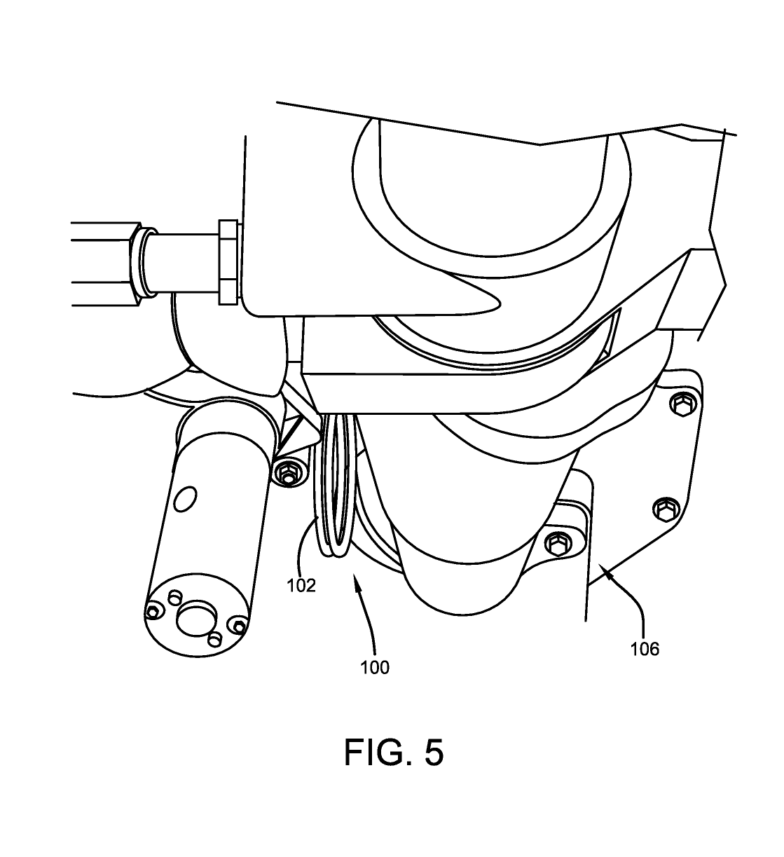

FIG. 5 illustrates the remote grease line device 100 in use. In operation, a user (not shown) would locate an inaccessible grease fitting, such as an idle gear shaft 116 that needs to be greased in a race vehicle 106 or other vehicle to maintain an idle gear bushing 101. The user would then secure the nipple fitting 104 to an end of the hose 102, via screwing (i.e. threading or jam nut) the nipple fitting 104 securely on the end of the hose 102. Once the nipple fitting 104 is secured to the hose 102, the user then secures the nipple fitting 104 to the idle gear shaft 116 that needs to be greased. The user can then position the hose in an accessible area, that allows the idle gear shaft 116 to be greased.

Once the hose 102 is in position, the user then secures a grease delivery device to the bulkhead fitting 103 for dispensing the grease or other fluid. Typically, the grease delivery device is a grease gun, but can be any suitable grease delivery device as is known in the art. Additionally, a grease line (from the grease gun) is secured to the bulkhead fitting 103 for dispensing grease through the hose 102 to the device with the grease fitting (i.e., the idle gear shaft 116). The user then dispenses grease from the grease gun to grease the idle gear shaft 116.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A remote grease line device comprising:
a hose comprising a first end, a second end, and a continuous opening therein extending between the first end and the second end;
a nipple fitting removably secured to the first end of the hose;
a bulkhead fitting removably secured to the second end of the hose;
wherein the nipple fitting is then secured to a device with a grease fitting; and
wherein the nipple fitting, the hose, and the bulkhead fitting are then positioned in an easily accessible position in a vehicle to allow for greasing of the device with the grease fitting.

2. The remote grease line device of claim 1, wherein the hose is manufactured of metal.

3. The remote grease line device of claim 2, wherein a grease delivery device dispenses grease through the grease line to the bulkhead fitting.

4. The remote grease line device of claim 3, wherein the grease delivery device is a grease gun.

5. The remote grease line device of claim 1, wherein the device with the grease fitting is an idle gear shaft for a racing vehicle.

6. The remote grease line device of claim 1, wherein the nipple fitting is a ¼ inch diameter nipple fitting.

7. The remote grease line device of claim 1, wherein the hose is a ¼ inch diameter hose.

8. The remote grease line device of claim 1, wherein the hose is approximately between 6 to 30 inches in length.

9. A remote grease line device comprising:
a hose comprising a first end, a second end, and a continuous opening therein extending between the first end and the second end;
a nipple fitting removably secured to the first end of the hose;
a bulkhead fitting removably secured to the second end of the hose;
wherein the nipple fitting is then secured to a device with a grease fitting; and
wherein the nipple fitting, the hose, and the bulkhead fitting are then positioned in an easily accessible position in a vehicle to allow for greasing of the device with the grease fitting; and
wherein a grease delivery device dispenses grease to the bulkhead fitting; and
wherein the grease delivery device comprises a grease line secured to the bulkhead fitting for dispensing grease into the bulkhead fitting and through the hose to the device with the grease fitting.

10. The remote grease line device of claim 9, wherein the grease delivery device is a grease gun.

11. The remote grease line device of claim 9, wherein the nipple fitting is a ¼ inch diameter nipple fitting.

12. The remote grease line device of claim 9, wherein the hose is a ¼ inch diameter hose.

13. The remote grease line device of claim 9, wherein the hose is approximately between 6 to 30 inches in length.

14. The remote grease line device of claim 9, wherein the hose is manufactured of stainless steel braid material.

15. The remote grease line device of claim 9, wherein the device with the grease fitting is an idle gear shaft for a racing vehicle.

16. A remote grease line device comprising:
a hose comprising a first end, a second end, and a continuous opening therein extending between the first end and the second end;
a nipple fitting removably secured to the first end of the hose;
a bulkhead fitting removably secured to the second end of the hose;
wherein the nipple fitting is then secured to an idle gear shaft for a racing vehicle; and
wherein the nipple fitting, the hose, and the bulkhead fitting are then positioned in an easily accessible position in the racing vehicle to allow for greasing of the idle gear shaft; and
wherein a grease delivery device dispenses grease to the bulkhead fitting and through the hose.

17. The remote grease line device of claim 16, wherein the grease delivery device comprises a grease line secured to the bulkhead fitting for dispensing grease into the bulkhead fitting and through the hose to the idle gear shaft.

18. The remote grease line device of claim 17, wherein the grease delivery device is a grease gun.

19. The remote grease line device of claim 16, wherein the nipple fitting is a ¼ inch diameter nipple fitting.

20. The remote grease line device of claim 16, wherein the hose is a ¼ inch diameter hose.
